(19) United States
(12) Patent Application Publication
(10) Pub. No.: US 2008/0114130 A1
(43) Pub. Date: May 15, 2008

(54) RESIN COMPOSITION FOR PRODUCTION OF HIGH TENACITY SLIT FILM, MONOFILAMENTS AND FIBERS

(76) Inventors: John Ashbaugh, Houston, TX (US); Frank Li, Houston, TX (US); Likuo Sun, Houston, TX (US)

Correspondence Address: FINA TECHNOLOGY INC, PO BOX 674412, HOUSTON, TX, 77267-4412, US

(21) Appl. No.: 11/558,666

(22) Filed: Nov. 10, 2006

(51) Int. Cl. C08L 23/12; C08L 23/04

(52) U.S. Cl. 525/240

(57) ABSTRACT

A polymer blend comprising polypropylene and polyethylene, wherein an article formed from the polymer blend has a tenacity of from greater than 6.5 g/9000 m. A method of preparing a polymer blend comprising blending a high crystallinity polypropylene and a high density polyethylene, wherein polyethylene is present in an amount of from 1 wt % to 30 wt % based on the total weight of the polymer blend, and extruding the polymer blend, wherein the extruded polymer blend has a tenacity greater than 6.5 g/9000 m. A method of preparing a polymer blend comprising preparing a polymer blend comprising a polypropylene homopolymer and a high density polyethylene, wherein the polypropylene homopolymer has a melting point of from 155° C. to 170° C., and forming the polymer blend into a monofilament having a tenacity greater than 6.5 g/9000 m and a draw ratio of from 4:1 to 20:1.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Technical Field

The present disclosure relates generally to the production of slit films, monofilaments, fibers and more specifically to the production of slit films, monofilaments, fibers and similar materials from a polymer blend.

2. Background

Synthetic polymeric materials, particularly polypropylene resins, are widely used in the manufacture of a variety of end-use articles ranging from medical devices to food containers. Polypropylene can be utilized in the production of slit films, monofilaments, fibers and similar materials. Common end use articles made from these materials include individual and woven fibers such as are useful in, for example, carpet backing, concrete reinforcement, artificial grass, geotextiles and other applications.

Manufacturing of slit films and monofilaments may be carried out using any plastics shaping process known in the art such as for example extrusion. One drawback to the production of such materials by extrusion is that the resin composition must possess sufficient tenacity and drawability to prevent the premature breakage of the material prior to the formation of slit films and monofilaments having the desired final dimensions. Therefore, a need exists for resin compositions having a desirable combination of tenacity and drawability.

### SUMMARY

Disclosed herein is a polymer blend comprising polypropylene and polyethylene, wherein an article formed from the polymer blend has a tenacity of from greater than 6.5 g/9000 m.

Further disclosed herein is a method of preparing a polymer blend comprising blending a high crystallinity polypropylene and a high density polyethylene, wherein polyethylene is present in an amount of from 1 wt % to 30 wt % based on the total weight of the polymer blend, and extruding the polymer blend, wherein the extruded polymer blend has a tenacity greater than 6.5 g/9000 m.

Also disclosed herein is a method of preparing a polymer blend comprising preparing a polymer blend comprising a polypropylene homopolymer and a high density polyethylene, wherein the polypropylene homopolymer has a melting point of from 155° C. to 170° C., and forming the polymer blend into a monofilament having a tenacity greater than 6.5 g/9000 m and a draw ratio of from 4:1 to 20:1.

The foregoing has outlined rather broadly the features and technical advantages of the present disclosure in order that the detailed description that follows may be better understood. Additional features and advantages of the embodiments will be described hereinafter that form the subject of the claims of the disclosure. It should be appreciated by those skilled in the art that the conception and the specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

FIG. 1 is a plot of tenacity at maximum as a function of draw ratio.

FIG. 2 is a plot of percent tape breaks as a function of draw ratio.

FIG. 3 is a plot of modulus at 5% elongation as a function of draw ratio.

### DETAILED DESCRIPTION OF THE EMBODIMENTS

Disclosed herein are resin compositions, hereinafter RCs, comprising polypropylene (PP) and polyethylene (PE). In an embodiment, the PP comprises a high crystallinity PP and the PE comprises a high density PE (HDPE). The RCs of this disclosure may be formed into products that display desirable physical properties such as an increased tenacity, drawability, and modulus when compared to products formed from an otherwise identical RC lacking a high crystallinity PP and a HDPE. The RC may be formed into products such as slit films, fibers and monofilaments by any methodology known to one of ordinary skill in the art; alternatively, the products are formed through the methodologies disclosed herein.

In an embodiment, the RC comprises a PP. The PP may be a homopolymer or a copolymer, for example a copolymer of propylene with one or more alpha olefin monomers such as ethylene, butene, hexene, etc. In an embodiment, the PP is a polypropylene homopolymer provided however that the homopolymer may contain up to 2 wt % of another alpha-olefin, including but not limited to C₂-C₈ alpha-olefins such as ethylene and 1-butene. Despite the potential presence of small amounts of other alpha-olefins, the PP is generally referred to as a polypropylene homopolymer.

In an embodiment the PP may be further characterized by a high degree of crystallinity. PPs having a “high” amount of crystallinity may also be characterized, at least in part, by a percent crystallinity of equal to or greater than 40%, alternatively equal to or greater than 45%, alternatively equal to or greater than 50%. This high degree of crystallinity may be indicated by the melting point, heat of fusion, tacticity, and/or recrystallization temperature of the PP.

In an embodiment, the PP homopolymer for use in the RC may have a melting point range of from 155° C. to 170° C.; alternatively from 160° C. to 170° C.; alternatively from 163° C. to 167° C. As used herein, “melting point” is measured by differential scanning calorimetry using a modified version of ASTM D 3418-99. Specifically, for a sample weighing between 5 and 10 g, the following standard test conditions involved heating the sample from 50° C. to 210° C. to erase the thermal history of the sample, followed by holding the sample at 210° C. for 5 minutes. The sample is then cooled to 50° C. to induce recrystallization and subsequently subjected to a second melt in the temperature range 50° C. to 190° C. For each of these temperature changes, the temperature is ramped at a rate of 10° C./min.

In an embodiment, the PP homopolymer for use in the RC may have a heat of fusion of from 90 Joules/gram (J/g) to 125 J/g; alternatively from 110 J/g to 120 J/g; alternatively from 115 J/g to 120 J/g. The heat of fusion (Hf) may also be indicative of the crystallinity of a polymer, and may be determined in accordance with ASTM E 794-85. For example, samples weighing approximately 7-10 mg may be sealed in sample pans. The differential scanning calorimetric data (DSC) is then recorded by first cooling the sample to −50° C., and then gradually heating it to 200° C. at a rate of 10° C./minute. The sample may then be kept at 200° C. for 5 minutes before a second cooling-heating cycle is applied. Both the first and second cycle thermal events are recorded. Areas under the melting peaks may then be measured and used to determine the heat of fusion and the degree of crystallinity. The percent crystallinity may be calculated using the formula: [area under the curve (Joules/gram)/B(Joules/gram)]*100, where B is the heat of fusion for the homopolymer of the major monomer component in the sample. The B values may be obtained from the literature, e.g., Polymer Handbook, Fourth Edition, published by John Wiley and Sons, New York 1999.

In an embodiment, the PP homopolymer for use in the RC may be characterized by a high isotacticity with the percentage of meso pentads being greater than 90%, alternatively greater than 92%, alternatively greater than 95%. The term “tacticity” refers to the arrangement of pendant groups in a polymer. For example, a polymer is “atactic” when its pendant groups are arranged in a random fashion on both sides of the main chain of the polymer. In contrast, a polymer is “isotactic” when all of its pendant groups are arranged on the same side of the chain and “syndiotactic” when its pendant groups alternate on opposite sides of the chain. In other words, in isotactic polypropylene the methyl groups lie on the same side of the polymer backbone in contrast to syndiotactic polypropylene in which the methyl groups lie on alternate sides of the polymer backbone. The stereoregularity of the polymeric product impacts both the physical and the mechanical properties of the product. As used herein, “isotacticity” is measured via ¹³C NMR spectroscopy using meso pentads and is expressed as percentage of meso pentads (% mmmm). As used herein, the term “meso pentads” refers to successive methyl groups located on the same side of the polymer chain.

The polypropylene used for this disclosure may be an isotactic polypropylene. The polypropylene may be prepared from conventional stereospecific catalysts used for preparing isotactic polymers, such as Ziegler-Natta or metallocene catalysts. In an embodiment, the PP is Ziegler-Natta catalyzed PP, alternatively high crystallinity, Ziegler-Natta catalyzed PP. The polypropylene may contain small amounts of non-isotactic polypropylene, including syndiotactic or atactic polypropylene, which may be present in less than 2% by weight of polypropylene.

In an embodiment, the PP homopolymer may have a recrystallization temperature of greater than 105° C., alternatively greater than 110° C., alternatively greater than 115° C. The high degree of crystallinity of the polypropylene may be further indicated by the recrystallization temperature. The recrystallization temperature is a measure of the peak temperature at which the polymer chains align into crystals, and may be determined using differential scanning calorimetry, DSC, according to ASTM D 3418-99.

An example of a suitable PP includes without limitation the high crystallinity low melt flow rate film grade polypropylene homopolymer sold as Total Petrochemicals 3270 by Total Petrochemicals USA, Inc. In an embodiment, the PP (e.g., 3270) has the physical properties set forth in Table 1.

TABLE 1

| | Typical Value | ASTM Method |
|---|---|---|
| Resin Properties | | |
| Melt Flow, g/10 min. | 2.0 | D-1238 |
| | | 230° C./ |
| | | 2.16 kg |
| Density, g/cc | 0.91 | D-1505 |
| Melting Point, ° F. (° C.) | 329 (165) | DSC |
| Film Properties, Tenter-frame, | | |
| Oriented | | |
| Haze, % | 1.0 | D-1003 |
| Gloss, 45°, % | 85 | D-2457 |
| Ultimate Tensile, psi MD (psi TD) | 28,000 (39,000) | D-882 |
| Tensile Modulus, psi MD (psi TD) | 420,000 (700,000) | D-882 |
| Elongation, % MD (TD) | 150 (60) | D-882 |
| WVTR, g/100 sq-in/24 hrs./mil | 0.2 | F-1249-90 |
| @100° F., 90% RH | | |

In an embodiment, the RC comprises polyethylene (PE). The PE may comprise low density polyethylene (LDPE), alternatively linear low density polyethylene (LLDPE), alternatively high density polyethylene (HDPE). In an embodiment, the PE has a density of less than 0.93 g/cc; alternatively from 0.93 g/cc to 0.95 g/cc; alternatively greater than 0.95 g/cc.

In an embodiment, the RC comprises HDPE. The HDPE may be a homopolymer or a copolymer, for example a copolymer of ethylene with one or more alpha-olefin monomers such as propylene, butene, hexene, etc. In an embodiment, the HDPE is a homopolymer. The HDPE may have a molecular weight distribution (MWD) of less than 25, alternatively less than 15, alternatively less than 7.0. As used herein, “molecular weight distribution” is the ratio of the weight average molecular weight to the number average molecular weight (Mw/Mn) of a polymer and may also be referred to as the polydispersity index. The HDPE may have a density of greater than 0.950 g/cc, alternatively greater than 0.960 g/cc.

In an embodiment, the RC comprises a HDPE having a melt flow rate of from 0.05 g/10 min. to 4 g/10 min., alternatively from 0.5 g/10 min. to 3 g/10 min., alternatively from 1 g/10 min. to 2 g/10 min. The melt flow rate is a measure of the ease of flow of the melt of a thermoplastic polymer. As defined herein, the MFR refers to the quantity of a melted polymer resin that will flow through an orifice at a specified temperature and under a specified load. The MFR may be determined using a dead-weight piston Plastometer that extrudes a polymer through an orifice of specified dimensions at a temperature of 190° C., and a load of 2.16 kg in accordance with ASTM D-1238.

An example of a suitable PE includes without limitation a high density low melt flow rate film grade polyethylene sold as Total Petrochemicals HDPE 6410 by Total Petrochemicals USA, Inc. In an embodiment, the PE (e.g., 6410) has the physical properties set forth in Table 2.

TABLE 2

| | | Typical | |
|---|---|---|---|
| | | Value | ASTM Method |
| Resin Properties⁽¹⁾ | | | |
| Melt Flow, | 190° C./2.16 kg | 1.2 | D-1238 |
| g/10 min. | 190° C./21.6 kg (HLMI) | 33.0 | |

| Density, g/cc | | 0.961 | D-792 |
|---|---|---|---|
| Melting Point, ° F. (° C.) | | 273 (134) | D-3417 |
| Film Properties, Oriented⁽¹⁾ | | | |
| Haze, % | | 15 | D-1003 |
| Gloss, % | | 50 | D-523 |
| Elmendorf | Machine Direction (MD) | 24 | D-1922 |
| Tear, g | Transverse Direction (TD) | 385 | |

| | | | |
|---|---|---|---|
| Tensile Strength at Yield, psi | MD | 3800 | D-882, A, 20 in/min |
| | TD | 4000 | |
| Tensile Strength at Break, psi | MD | 7500 | D-882, A, 20 in/min |
| | TD | 3400 | |
| Elongation at Break, % | MD | 700 | D-882, A, 20 in/min |
| | TD | 700 | |

| | | | |
|---|---|---|---|
| Secant Modulus, | 1% Strain(MD/TD) | 125/128 | D-882, A, 1 in/min |
| kpsi | 2% Strain(MD/TD) | 100/102 | |

| | | |
|---|---|---|
| WVTR⁽²⁾ @ 100° F., g/100 sq-in/day | 0.4 | E96/66 |

⁽¹⁾Film was produced at 1.0 mil with a 2.5:1 BUR in a low stalk configuration.
⁽²⁾Water Vapor Transmission Rate

Standard equipment and processes for production of the PP and PE components of the RC are known to one skilled in the art. The olefin polymerization may be carried out using solution phase, gas phase, slurry phase, bulk phase, high pressure processes or combinations thereof, for example. See, for example, U.S. Pat. Nos. 5,525,678, 6,420,580, 6,380,328, 6,359,072, 6,346,586, 6,340,730, 6,339,134, 6,300,436, 6,274,684, 6,271,323, 6,248,845, 6,245,868, 6,245,705, 6,242,545, 6,211,105, 6,207,606, 6,180,735 and 6,147,173, which are incorporated by reference herein.

Examples of solution processes are described in U.S. Pat. Nos. 4,271,060, 5,001,205, 5,236,998 and 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig or from 250 psig to 350 psig, for example. The reactor temperature in a gas phase process may vary from 30° C. to 120° C., or from 60° C. to 115° C., or from 70° C. to 110° C. or from 70° C. to 95° C., for example. See, for example, U.S. Pat. Nos. 4,543,399, 4,588,790, 5,028,670, 5,317,036, 5,352,749, 5,405,922, 5,436,304, 5,456,471, 5,462,999, 5,616,661, 5,627,242, 5,665,818, 5,677,375 and 5,668,228, which are incorporated by reference herein.

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process. However, a process may be a bulk process, a slurry process or a bulk slurry process, for example.

As stated previously, hydrogen may be added to the process for a variety of reasons. For example, hydrogen may be added to increase the melt flow of the resultant polymer, to increase the catalyst activity or, for molecular weight control of the resultant polymer. In an embodiment, hydrogen may be present in the reaction mixture in an amount of from 0 to 400 ppm, alternatively from 5 ppm to 200 ppm, alternatively from 10 ppm to 150 ppm.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. The loop reactor may be maintained at a pressure of from 27 bar to 45 bar and a temperature of from 38° C. to 121° C., for example. Reaction heat may be removed through the loop wall via any method known to one skilled in the art, such as via a double-jacketed pipe.

Alternatively, other types of polymerization processes may be used, such stirred reactors in series, parallel or combinations thereof, for example. Upon removal from the reactor, the polymer may be passed to a polymer recovery system for further processing, such as addition of additives and/or extrusion, for example.

Any catalyst known in the art for the polymerization propylene or ethylene such as a metallocene catalyst or a Ziegler-Natta catalyst may be used in the preparation of these polymers. Examples of suitable Ziegler-Natta catalysts include without limitation those disclosed in U.S. Pat. No. 6,174,971 and in the following patent applications: U.S. patent application Ser. Nos. 09/687,378, 09/687,688 and 09/687,560, each of which is incorporated herein by reference in its entirety. Methods, catalysts and conditions for the preparation of a suitable HDPE are also disclosed in U.S. Published Application 2003/0030174, which is incorporated by reference herein in its entirety.

In embodiments the RC comprises a blend of PP and PE wherein the PE is a HDPE and the PP is a high crystallinity PP, for example PP having a melting point, heat of fusion and/or isotacticity in the disclosed ranges. In such embodiments, the RC may contain HDPE in amounts of from 1 wt % to 30 wt % based on the total weight of the polymer blend comprising the PP and HDPE. Alternatively, the RC may contain HDPE present in amounts of from 2 wt % to 20 wt % based on the total weight of the polymer blend. Alternatively, the RC may contain HDPE present in amounts of from 2 wt % to 10 wt % based on the total weight of the polymer blend. Alternatively, the RC may contain HDPE present in amounts of from 2 wt % to 5 wt % based on the total weight of the polymer blend.

In an embodiment, the RC may also contain additives to impart desired physical properties, such as printability, increased gloss or a reduced blocking tendency. Examples of additives include without limitation stabilizers, ultra-violet screening agents, oxidants, antioxidants, anti-static agents, ultraviolet light absorbents, fire retardants, processing oils, mold release agents, coloring agents, pigments/dyes, fillers, and/or other additives known to one skilled in the art with or without other components. The aforementioned additives may be used either singularly or in combination to form various formulations of the polymer and/or may be added directly to the extruder. For example, stabilizers or stabilization agents may be employed to help protect the polymer resin from degradation due to exposure to excessive temperatures and/or ultraviolet light. These additives may be included in amounts effective to impart the desired properties. Effective additive amounts and processes for inclusion of these additives to polymeric compositions are known to one skilled in the art.

In an embodiment, the RCs of this disclosure are used to create slit films, monofilaments, and fibers which may be further formed into a consumer product.

In an embodiment, the RCs of this disclosure are used to produce slit films. The slit films of this disclosure may be produced by any method and under any conditions known to one skilled in the art for the production of films. In an embodiment, the polymeric compositions are formed into films by the process described herein.

In an embodiment, the RCs of this disclosure are formed into slit films by an extrusion process wherein PP homopolymer and HDPE are blended together in the molten state. The polymers may be mixed together in pelletized, fluff, or powder form prior to entering the extruder. Alternatively, the polymers may be added separately to the extruder. Additives may be introduced to the extruder as well. The molten polymer may then be extruded through a slot or die to form a thin, extruded sheet (typically having a thickness greater than 10 mils) or film (typically having a thickness equal to or less than 10 mils). The extruded sheet or film is then adhered to a cooled surface such as a chill roll, or alternatively guided into a water bath. The chill roll or water bath functions to immediately quench the sheet or film. The sheet or film may then be passed through rollers designed to stretch the sheet in differing axial directions to produce oriented films. The extent of stretching is reported in terms of draw ratios which refer to the extent of stretching in the x versus y direction of the film. For example a draw ratio of 4:1 in the x-direction indicates the film was stretched 4 times its original length in the x-direction. In an embodiment the film is uniaxially oriented, by drawing the sheet in the longitudinal or machine direction on one or more rollers that may be heated. Drawing the films increases the tensile strength of the films by orienting the polymer molecules. After the films are drawn, they may be annealed in an annealing oven. Annealing may reduce the internal stresses created during the drawing process. The films may be further trimmed and rolled for transport or storage. Alternatively, the sheets may be slit longitudinally with a slitter prior to drawing, or a plurality of tapes may be extruded through a plurality of die openings.

Compared to slit films, monofilaments, films and fibers prepared from PP homopolymers, the slit films, monofilaments, films and fibers of this disclosure may exhibit more favorable mechanical properties such as increased tenacity, modulus and improved drawability.

The RC disclosed herein may produce end-use articles constructed there from that display an improved tenacity as measured on the finished fiber or monofilament. Tenacity expresses the relative tensile strength of the slit film, monofilament, or fiber expressed in grams of breaking force per denier unit. Denier denotes the system of measuring the weight of a continuous filament or fiber. Numerically, a denier is the equivalent to the weight in grams of 9,000 m of continuous filament fiber. In an embodiment, the slit films or filaments produced according to this disclosure have tenacities of greater than 6.5 g/9000 m; alternatively greater than 7 g/9000 m; alternatively greater than 7.5 g/9000 m; alternatively from greater than 6.5 g/9000 m to 12 g/9000 m; alternatively from greater than 6.5 g/9000 m to 10 g/9000 m; alternatively from greater than 6.5 g/9000 m to 9 g/9000 m; alternatively from 7 g/9000 m to 9 g/9000 m; alternatively from 7.5 g/9000 m to 9 g/9000 m as determined using an Instron 1122-550R in a constant rate tensile loading mode using a 100N load cell. The gauge length was set at 2 inches and the deformation rate was 5 in/min.

The RCs disclosed herein may produce end-use articles constructed there from that display a desirable stiffness as determined by the modulus at 5% elongation. The modulus is a measure of the stress to strain response of a material or the ability to withstand deformation under an applied force. In an embodiment, the RCs disclosed herein yield slit tapes having a modulus at 5% elongation measured in grams per denier (g/den) of from 20 g/den to 100 g/den, alternatively from 25 g/den to 90 g/den, alternatively, from 35 g/den to 80 g/den as determined using an Instron 1122-550R in a constant rate tensile loading mode using a 100N load cell. The gauge length was set at 2 inches and the deformation rate was 5 in/min.

The RC and fibers and filaments produced there from may display an improved drawability when compared to fibers and filaments prepared from conventional RCs as determined by the draw ratio at which the films and filaments can be produced. A higher working draw ratio is desirable for two reasons. Firstly, after polypropylene fibers are drawn to a certain extent, they may be damaged by further drawing, thus reducing mechanical properties of the products, such as strength. Secondly, when the fibers/tapes are processed, it is desirable to process quickly and avoid breaks. When breaks occur, the tapes/monofilaments must be restrung, leading to production downtime and processing issues. The RC disclosed herein has the ability to produce a film with a draw ratio of from 3:1 to 15:1; alternatively from 5:1 to 12:1; alternatively from 6:1 to 10:1. The RC disclosed herein has the ability to produce a monofilament with a draw ratio of from 4:1 to 20:1; alternatively from 5:1 to 18:1; alternatively from 6:1 to 15:1.

As mentioned previously, it is desirable to minimize the percent breaks during fiber processing. Typical processing percent breaks of less than 5% are desirable in order to minimize the costly downtime required to bring the system up again. In an embodiment, the RCs disclosed herein yield slit films having a decrease in percent breaks during processing as compared with slit films formed from resin composition lacking the PP homopolymer, HDPE blend disclosed herein. For example, at a draw ratio of 8:1, the RCs of this disclosure yield slit film tapes with 42% less tape breaks than slit tapes formed from propylene homopolymer alone. Alternatively, at a draw ratio of 9:1, the RCs of this disclosure yield slit film tapes with 23% less tape breaks than slit tapes formed from propylene homopolymer alone.

Examples of end use articles formed by the RC of this disclosure include tapes, slit films, monofilaments, fibers, and products incorporating same such as woven materials, spun materials, yarns, fabrics, etc. In an embodiment, the end-use articles are individual fibers for use in concrete reinforcement and fibers suitable for use as binding fibers in multi-fiber woven fabrics. Additional end use articles would be apparent to those skilled in the art. The RCs of this disclosure may be converted to end-use articles by any suitable method.

### EXAMPLES

The embodiments having been generally described, the following examples are given as particular embodiments and to demonstrate the practice and advantages thereof. It is understood that the examples are given by way of illustration and are not intended to limit the specification of the claims in any manner. Thus, although slit film tapes are discussed in the examples, it should be apparent to those skilled in the art that the RCs herein disclosed may be used to form different materials, and the disclosure should not be limited to slit films. Unless otherwise indicated, physical properties were determined in accordance with the test methods previously identified in the detailed description.

### Example 1

To test various polypropylenes for the production of high tenacity tape, six polypropylenes were chosen, each of which is commercially available from Total Petrochemicals USA, Inc. One polypropylene is a low melt flow rate high crystallinity propylene homopolymer sold as Total Petrochemicals 3270, having generally the physical properties set forth in Table 1. Five other polypropylene homopolymers were used in the investigation. These are: Total Petrochemicals TP 3281, a low melt flow rate polypropylene homopolymer having generally the properties in Table 3; Total Petrochemicals TP M3282MZ, a homopolymer clarified metallocene sheet extrusion and thermoforming grade having generally the physical properties shown in Table 4; Total Petrochemicals TP EOD01-30, a 4 MFR metallocene-catalyzed polypropylene homopolymer having generally the physical properties shown in Table 5; and Total Petrochemicals TP 3462, a 4.1 MFR polypropylene homopolymer having generally the physical properties shown in Table 6. TP 3462 is a standard polypropylene homopolymer used in the industry to produce slit films. The low melt flow rate polypropylene impact copolymer sold as Total Petrochemicals TP 4280W having generally the physical properties in Table 7 was also investigated.

TABLE 3
TP 3281

| | | | ASTM |
|---|---|---|---|
| | | Typical Value | Method |
| Resin Properties | | | |
| Melt Flow, g/10 min. “L” | | 1.35 | D-1238 |
| | | | Condition |
| Density, g/cc | | 0.905 | D-1505 |
| Melting Point, ° F., (° C.) | | 330 (165) | DSC⁽¹⁾ |
| Mechanical Properties | | | |
| Tensile @ Yield, psi (MPa) | | 4900 (34.0) | D-638 |
| Elongation, % | | 8.0 | D-638 |
| Tensile Modulus, psi (MPa) | | 220,000 (1515) | D-638 |
| Flexural Modulus, psi (MPa) | | 200,000 (1380) | D-790 |
| Izod Impact @ | Notched-ft.lb./in. (J/m) | 0.8 (42.0) | D-256A |
| 73° F. | Unnotched-ft.lb./in. (J/m) | 30.0 (1590) | |
| Hardness | Shore D | 81 | D-1706 |
| | Rockwell R | 90 | D-785A |
| Thermal Properties | | | |
| Heat Deflection | ° F. @ 66 psi | 220 | D-648 |
| | ° C. @ 4.64 kg/sq-cm | 104 | |
| Coefficient of | in./in./° F. × 10⁻⁵ | 5.6 | D-696 |
| Linear Thermal | cm./cm./° C. × 10⁻⁵ | 10 | |
| Expansion | | | |

⁽¹⁾MP determined with a DSC-2 Differential Scanning Calorimeter.

TABLE 4
TP M3282MZ

| | | Typical Value | ASTM Method |
|---|---|---|---|
| Resin Properties | | | |
| Melt Flow, g/10 min. | | 2.3 | D-1238 |
| | | | Condition “L” |
| Density, g/cc | | 0.905 | D-1505 |
| Melting Point, ° F., (° C.) | | 307 (153) | DSC⁽¹⁾ |
| Mechanical Properties,⁽¹⁾ | | | |
| Tensile, psi (M Pa) | | 4,900 (33.8) | D-638 |
| Elongation, % | | >72 | D-638 |
| Flexural Modulus, psi (M Pa) | | 216,000 (1,490) | D-790 |
| Izod Impact @ | Notched-ft-lb/in | 1.3 (65) | D-256A |
| 73° F. | (J/m) | | |
| Thermal Properties⁽¹⁾ | | | |
| Heat Deflection | ° F. at 66 psi | 207 | D-648 |
| | ° C. at 4.64 | 97 | |
| | kg/sq-cm² | | |

⁽¹⁾MP determined with a Differential Scanning Calorimeter.

TABLE 5
TP EOD 01-30

| | Typical Value | ASTM Method |
|---|---|---|
| Resin Properties | | |
| Melt Flow, g/10 min. | 4 | D-1238 |
| Melt Point, ° F., (° C.) | 302 (150) | DSC⁽¹⁾ |
| Physical Properties⁽¹⁾, | | |
| Oriented Film-0.7 mil (18 microns) | | |
| Ultimate Tensile MD, psi (M Pa) | 20,000 (140) | D-882 |
| Ultimate Tensile TD, psi (M Pa) | 37,000 (250) | D-882 |
| Ultimate Elongation MD, % (TD) | 160 (47) | D-882 |
| 1% Secant Modulus MD, psi (Gpa) | 240,000 (1.7) | D-882 |
| 1% Secant Modulus TD, psi (Gpa) | 390,000 (2.7) | D-882 |
| Haze, % | 0.2 | D-1003 |
| Contact Clarity, % | 62 | |
| Gloss, % | 98 | D-2457 |

⁽¹⁾MP determined with a DSC-2 Differential Scanning Calorimeter.

TABLE 6
TP 3462

| | | Typical Value | ASTM Method |
|---|---|---|---|
| Resin Properties | | | |
| Melt Flow, g/10 min. | | 4.1 | D-1238 |
| | | | Condition “L” |
| Density, g/cc | | 0.905 | D-1505 |
| Melting Point, ° F., (° C.) | | 330 (165) | DSC⁽¹⁾ |
| Mechanical Properties⁽¹⁾ | | | |
| Tensile @ Yield, psi (MPa) | | 5000 (34.5) | D-638 |
| Elongation, % | | 12 | D-638 |
| Tensile Modulus, psi (MPa) | | 220,000 (1,515) | D-638 |
| Flexural Modulus, psi (MPa) | | 200,000 (1,380) | D-790 |
| Izod Impact @ | Notched-ft.lb./in. | 0.6 (31.7) | D-256A |
| 73° F. | (J/m) | | |
| | Unnotched-ft.lb./in. | 17.0 (900) | |
| | (J/m) | | |
| Thermal Properties | | | |
| Heat Deflection | ° F. @ 66 psi | 225 | D-648 |
| | ° C. 4.64 | 107 | |
| | kg/sq-cm | | |

| Fiber Properties⁽²⁾ | |
|---|---|
| Tenacity, g/denier | 5.8 |
| Elongation, % | 28 |

⁽¹⁾MP determined with DSC-2 Differential Scanning Calorimeter.
⁽²⁾Sample Processed at 6:1 draw ratio and 450 degrees F. (232 degrees C.) melt temperature.

TABLE 7
TP 4280W

| | | Typical Value | ASTM Method |
|---|---|---|---|
| Resin Properties | | | |
| Melt Flow, g/10 min. | | 1.3 | D-1238 |
| Density, g/cc | | 0.905 | D-1505 |
| Melting Point, ° C. | | 160–165 | TOTAL |
| | | | Polypropylene |
| | | | Method |
| Mechanical Properties | | | |
| Tensile, Strength @ Yield, psi (MPa) | | 3,500 (24) | D-638 |
| Elongation at Yield, % | | 9 | D-638 |
| Flexural Modulus, psi (MPa) | | 175,000 (1200) | D-790 |
| Izod Impact | @ 23° C. ft.lb./in. | NoBreak | D-256 |
| (Notched) | (J/m) | (NoBreak) | |
| | @ −20° C.-ft.lb./in. | 1.3 (65) | |
| | (J/m) | | |
| Charpy Impact | @ 23° C. kJ/sq-m | No Break | DIN 53453 |
| Strength | @ −20° C. kJ/sq-m | 8 | |

| Thermal Properties | | |
|---|---|---|
| Vicat Softening Point, ° C. | 150 | D-1525 |
| Heat Deflection, ° C. | 90 | D-648 |

Using processing parameters set forth in Table 8, on a BOULIGNY slit film tape line, six slit tapes were prepared using the above-mentioned polypropylenes. ST1 is a blend of TP 3270 with 5 wt % HDPE 6410, a high density polyethylene having generally the physical properties shown in Table 2. ST2 is a blend of TP 3281 with 5 wt % HDPE 6410, ST3 is a blend of M3282MZ with 5 wt % HDPE 6410. ST4 is a blend of EOD 01-30 with 5 wt % HDPE 6410. ST5 is a blend of 50% TP 3270 with 50% TP 4280W. ST6, a control tape, contains TP-3462, a standard polypropylene homopolymer used to make slit films.

TABLE 8
Tape Line Conditions

| | |
|---|---|
| Line Speed, fbm | 70 |
| Melt Temperature, ° C. | 250 |
| Air Gap, in | 0.5 |
| Bath Temperature, ° F. | 100 |
| Draw Oven, ° C. | 175 |
| Draw Ratio | 5, 6, 7, 8, 9, 10 |
| Annealing, ° C. | 290 |
| Relaxation, % | 3 |

Tenacity, tensile moduli, total energy (toughness), and elongation of the slit tapes were measured with an Instron 1122-550R in a constant rate tensile loading mode using a 100N load cell. The gauge length was set at 2 inches and the deformation rate was 5 in/min.

Table 9 shows the physical properties of the slit tapes 1 though 6 at the indicated draw ratios.

TABLE 9
Physical Properties of Slit Tapes

| | | | | | | | Tenacity | Modulus | Draw- |
|---|---|---|---|---|---|---|---|---|---|
| | | Tenacity | Tenacity | | | Total | @5% | @5% | ability, |
| Tape | Draw | @ Max, | @ Brk, | % Elongation @ | % Elongation @ | Energy, | Elongation, | Elongation, | % Tape |
| No. | Ratio | g/den | g/den | Max | Brk | lb-in | g/den | g/den | Breaks |
| ST1 | 5 | 5.6 | 5.1 | 29 | 30 | 12.2 | 2.1 | 34.7 | 0 |
| ST1 | 6 | 7.1 | 6.4 | 23 | 23.9 | 12.1 | 3 | 49.5 | 0 |
| ST1 | 7 | 8.1 | 7.3 | 22 | 23.6 | 13.9 | 3.5 | 57.6 | 0 |
| ST1 | 8 | 7.9 | 7.1 | 16.6 | 19.1 | 10.7 | 4.1 | 72.4 | 12 |
| ST1 | 9 | 7.8 | 7 | 13.2 | 17.7 | 9.8 | 4.5 | 79 | 77 |
| ST1 | 10 | — | — | — | — | — | — | — | 100 |
| ST2 | 5 | 6.8 | 6.1 | 23.6 | 25 | 11.2 | 2.6 | 40.4 | 0 |
| ST2 | 6 | 7.4 | 6.7 | 21.7 | 23.4 | 12.1 | 3.2 | 54.3 | 14 |
| ST2 | 7 | — | — | — | — | — | — | — | 100 |
| ST2 | 8 | — | — | — | — | — | — | — | — |
| ST2 | 9 | — | — | — | — | — | — | — | — |
| ST2 | 10 | — | — | — | — | — | — | — | — |
| ST3 | 5 | 4.8 | 4.3 | 26.8 | 28.8 | 10 | 1.9 | 28.3 | 5 |
| ST3 | 6 | 6.1 | 5.8 | 24 | 24.8 | 10.1 | 2.4 | 37.1 | 37 |
| ST3 | 7 | 7 | 6.7 | 20.7 | 20.9 | 9.2 | 2.8 | 45.2 | 74 |
| ST3 | 8 | — | — | — | — | — | — | — | 100 |
| ST3 | 9 | — | — | — | — | — | — | — | — |
| ST3 | 10 | — | — | — | — | — | — | — | — |
| ST4 | 5 | 4.2 | 4.1 | 36.4 | 40.4 | 13.2 | 1.5 | 21.9 | 0 |
| ST4 | 6 | 5.9 | 5.3 | 26.7 | 28.6 | 12.2 | 2.3 | 36.7 | 0 |
| ST4 | 7 | 7 | 6.5 | 21.5 | 23 | 10.9 | 2.8 | 44.8 | 0 |
| ST4 | 8 | 8.1 | 7.6 | 18.8 | 19.6 | 9.8 | 3.4 | 57.7 | 5 |
| ST4 | 9 | 7.7 | 7.3 | 15.9 | 17.4 | 8.6 | 3.7 | 62.9 | 19 |
| ST4 | 10 | 7.2 | 6.6 | 12.9 | 14.3 | 6.8 | 4.2 | 72.2 | 98 |
| ST5 | 5 | 5.8 | 5.8 | 27.9 | 28.7 | 11.7 | 2.1 | 34.9 | 0 |
| ST5 | 6 | 6.5 | 6.5 | 22.2 | 22.2 | 9.8 | 2.6 | 42.8 | 7 |
| ST5 | 7 | 7.4 | 7.4 | 20 | 20 | 9.5 | 3.1 | 51 | 23 |
| ST5 | 8 | 8 | 8 | 18.5 | 18.5 | 9.5 | 2.5 | 58.5 | 65 |
| ST5 | 9 | — | — | — | — | — | — | — | 100 |
| ST5 | 10 | — | — | — | — | — | — | — | — |
| ST6 | 5 | 5.8 | 5.8 | 28.2 | 28.6 | 12 | 2.1 | 34.5 | 0 |
| ST6 | 6 | 7.2 | 7.2 | 25.3 | 25.3 | 12.4 | 2.7 | 44.6 | 0 |
| ST6 | 7 | 6.4 | 6.4 | 15.5 | 19 | 7.8 | 3 | 51.1 | 0 |
| ST6 | 8 | 5.6 | 5.6 | 10.6 | 12 | 4.2 | 3.6 | 60.7 | 21 |
| ST6 | 9 | — | — | — | — | — | — | — | 100 |
| ST6 | 10 | — | — | — | — | — | — | — | — |

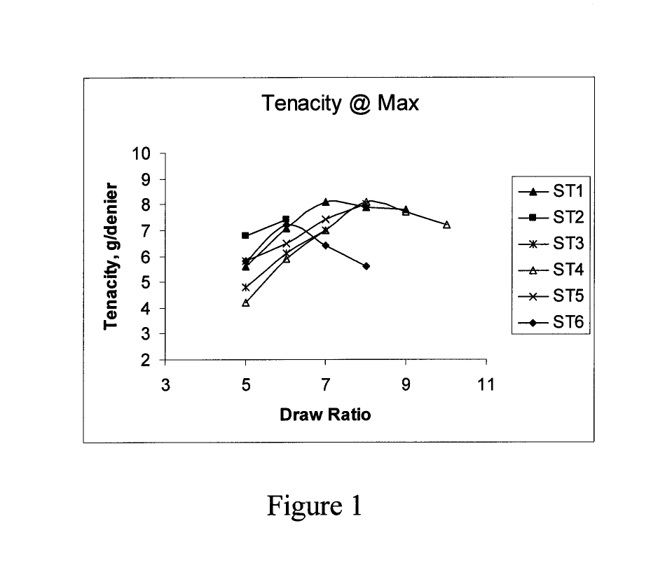

A plot of tenacity at maximum versus draw ratio is shown in FIG. 1. The results demonstrate that at a draw ratio of 7:1, a typical commercial draw ratio, the ranking in terms of tenacity of the resins tested is ST1>ST5>ST4>ST3>ST6. ST2 did not achieve a draw ratio of 7:1. ST1, the tape having the resin composition as herein disclosed, achieved a tenacity of 8.1 g/denier at this high draw ratio. Typical commercial slit films have tenacities of 4 g/denier to 6 g/denier. The performance of ST1 is significant because the tenacity is achieved at a lower draw ratio of 7:1 and maintained at the higher draws, having tenacities of 7.9 and 7.8 at draw ratios of 8:1 and 9:1 respectively.

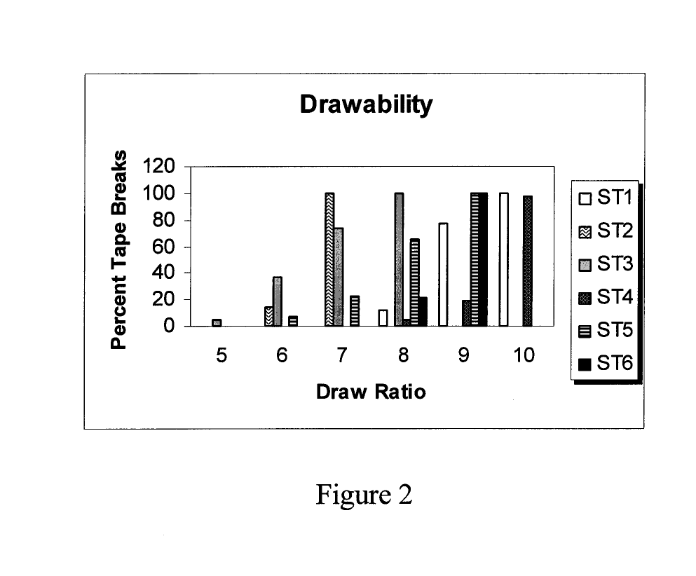

A plot of percent tape breaks for each sample as a function of draw ratio is presented as FIG. 2. The ST4 sample containing EO D01-30, the higher melt flow rate metallocene polypropylene, with 5 wt % polyethylene gave the best draw performance, with ST1, the sample containing TP 3270 with 5 wt % HDPE 6410, having the next best performance, exhibiting less than 80% breaks at a draw ratio of 9:1.

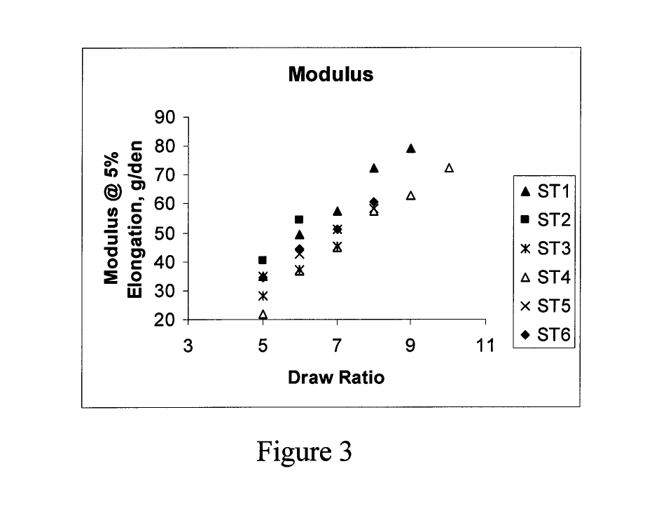

A plot of modulus at 5% elongation for each sample as a function of draw ratio is presented as FIG. 3. The ST1 sample gave the highest modulus at draw ratios of 7:1, 8:1, and 9:1.

The slit tapes of the present disclosure, ST1, also display a greater toughness than conventional slit tape made from propylene homopolymer, e.g. ST6, as seen from the total energy data in Table 9. Specifically, ST1 has 13.9 lb-in total energy at a draw ratio of 7:1, while ST6 has 7 lb-in total energy at this draw ratio. ST2-ST5 display total energies less than ST1 as well, ranging from 7.8 lb-in to 10.9 lb-in at a draw ratio of 7:1.

The results demonstrate that RCs comprising PP homopolymer and HDPE as disclosed yield high tenacity products (i.e. tape) with a good drawability, tenacity, stiffness, and toughness. Furthermore, slit tapes of this disclosure exhibit a greater tenacity and modulus at higher draw ratios than conventional polypropylene tapes formed from propylene homopolymers.

While embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from 1 to 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the disclosed embodiments. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A polymer blend comprising polyethylene and Ziegler-Natta catalyzed polypropylene, wherein an article formed from the polymer blend has a tenacity of from greater than 6.5 g/9000 m.

2. The polymer blend of claim 1 wherein the polypropylene is a homopolymer.

3. The polymer blend of claim 1 wherein the polypropylene has a percent crystallinity of equal to or greater than 40%.

4. The polymer blend of claim 1 wherein a melting point of the polypropylene is from 155° C. to 170° C.

5. The polymer blend of claim 1 wherein the heat of fusion of the polypropylene is from 90 Joules/gram to 125 Joules/gram.

6. The polymer blend of claim 1 wherein the polypropylene has a percentage of meso pentads greater than 90%.

7. The polymer blend of claim 1 wherein the recrystallization temperature of the polypropylene is greater than 105° C.

8. The polymer blend of claim 1 wherein the polypropylene comprises less than or equal to 2 wt % copolymer.

9. The polymer blend of claim 1 wherein the polyethylene comprises high density polyethylene.

10. The polymer blend of claim 9 wherein the polyethylene has a density of greater than or equal to 0.95 g/cc.

11. The polymer blend of claim 1 wherein polyethylene is present in an amount of from 1 wt % to 30 wt % and the polypropylene is in an amount of from 99 wt. % to 70 wt. % based on the total weight of the polymer blend.

12. The polymer blend of claim 1 wherein the polyethylene has a melt flow rate of from 0.05 g/10 min to 4 g/10 min, as determined in accordance with ASTM D-1238.

13. An article formed from the polymer blend of claim 1.

14. The article of claim 13 having a modulus of from 20 g/denier to 100 g/denier.

15. The article of claim 13 comprising a uniaxially-oriented resin.

16. The article of claim 13 wherein the article is selected from the group comprising tapes, slit film tapes, monofilaments, and fibers.

17. The article of claim 13 comprising a monofilament fiber having a draw ratio of from 4:1 to 20:1.

18. The article of claim 13 comprising a slit film or tape.

19. The article of claim 18 having a draw ratio of from 3:1 to 15:1.

20. A method of preparing a polymer blend comprising:
blending a high crystallinity polypropylene and a high density polyethylene, wherein polyethylene is present in an amount of from 1 wt % to 30 wt % based on the total weight of the polymer blend; and
extruding the polymer blend, wherein the extruded polymer blend has a tenacity greater than 6.5 g/9000 m.

21. A method of preparing a polymer blend comprising:
preparing a polymer blend comprising a polypropylene homopolymer and a high density polyethylene, wherein the polypropylene homopolymer has a melting point of from 155° C. to 170° C.; and
forming the polymer blend into a monofilament having a tenacity greater than 6.5 g/9000 m and a draw ratio of from 4:1 to 20:1.
